(19) United States
(12) Patent Application Publication
(10) Pub. No.: US 2012/0091028 A1
(43) Pub. Date: Apr. 19, 2012

(54) PERSONALIZED ORNAMENTAL ARTICLES

(75) Inventor: Jacob Paul FUHRMAN, White Bear Township, MN (US)

(73) Assignee: Custom Goldsmithing Inc., Little Canada, MN (US)

(21) Appl. No.: 13/272,915

(22) Filed: Oct. 13, 2011

Related U.S. Application Data
(60) Provisional application No. 61/392,987, filed on Oct. 14, 2010.

(51) Int. Cl. G06Q 30/06; B65D 69/00; B29C 47/92; G06Q 90/00; H04N 1/04

(52) U.S. Cl. 206/568; 705/500; 358/474; 264/40.4

(57) ABSTRACT

A method for obtaining a fingerprint and for making an ornamental article having the fingerprint includes sending a kit to a customer including a photo reactive medium and receptor, so that a person can create a fingerprint on the receptor. The fingerprint is received from the customer after the fingerprint is created using the photo reactive medium and receptor. Using the photo reactive medium and receptor allows the fingerprint to be easily formed and sufficiently set, with a high amount of detail and accuracy. Further, the photo reactive medium and receptor can allow for a printed created to not be compromised between the time the fingerprint is made and the time the fingerprint is received by the ornamental article manufacturer.

This application claims the benefit of U.S. Provisional Application Ser. No. 61/392987 filed on Oct. 14, 2010, which is titled “Personalized Ornamental Articles”, the entirety of which is incorporated by reference herewith.

### FIELD

This document relates generally to ornamental articles and a method for making the same and particularly, but not by way of limitation, to a method of obtaining a person's fingerprint using a photo reactive medium, which is used for example to make jewelry.

### BACKGROUND

Personalized ornamental articles are sometimes designed, customized, and manufactured, for instance, by jewelers for certain individual customers. Such ornamental articles have been known to be made from reproductions of the contours of the human body, such as a fingerprint or a footprint, to provide a unique and identifiable representation of that person and to produce a pleasing and attractive article of ornamentation or personal adornment, such as for a family keepsake.

In the example of a person's finger or footprint(s), in order to obtain an accurate three-dimensional replication of the finger or footprint, one must first obtain the print. Current methods for obtaining a fingerprint have included a jeweler sending a kit to a customer for producing the fingerprint, where the customer creates the fingerprint and sends it back to jeweler. Such kits typically include a wax material, oftentimes beeswax, for the customer to produce the fingerprint. The customer is to press his/her finger or have another person such as a family member or friend press his/her finger on the beeswax and then send the beeswax with the print on it back to the jeweler's studio for manufacturing of the particular ornamental item.

However, the wax material used in such kits is problematic since the material does not allow a print to set. The nature of such wax materials is that they are soft and easily malleable making them suitable for creating a print, but not suitable for setting the print after it is made. This problem of setting the print is critical, since the wax material (with the print(s) on it) is sent back to the jeweler and the print(s) may become compromised, distorted, ruined, or otherwise altered between the time the print is made until it finally reaches the jeweler, such as in transit. Such a result is detrimental since the print is no longer accurate and cannot be used. For these and other reasons, there is a need for obtaining an accurate and lasting print, for example, a fingerprint or footprint, which can be subsequently transported to a studio for manufacturing and creating the cast replication.

Applicant's previous method, which is disclosed in copending U.S. application Ser. No. 12/464391, filed on May 12, 2009 (having US Application Publication No. 2009/0283429), employed a thermoplastic medium to obtain and set the impression. Such an approach has been suitable for example to capture an impression actually made by one making the impression.

### SUMMARY

An improved kit and method of obtaining one's print can be achieved by using a medium that facilitates setting a more accurate representation of the print, and that can be used to obtain a mold useful for making the ornamental article, such as for example jewelry. A kit and method described herein employs a photo reactive medium to obtain the print.

As used herein, obtaining a print includes a print of a portion of a human or animal body, e.g., fingerprint, footprint, paw, etc. The print is made by contacting and pressing a portion of the body onto a photo reactive medium and then contacting and pressing the portion of one's body onto a photo reactive receptor. The photo reactive medium and receptor are materials that can accurately capture a two-dimensional representation of a print on the receptor, which can then be suitably used to obtain a three dimensional mold. By using the photo reactive medium and receptor, a print for example a fingerprint can be made which sets quickly, has a high amount of detail, and which is difficult to compromise until it reaches a jeweler, such as for example during shipping. The print that is captured is stable, such that it is suitable for long term storage, cataloguing, and reuse of the print. The photo reactive medium is also suitable for being electronically scanned for cataloguing and later use.

In some embodiments, the photo reactive medium is an inkless photo reactive medium that can be contacted with one's body. The photo reactive receptor, for example can be a photo reactive paper, and can be contacted with one's body after one has mad made contact with the photo reactive medium.

In one embodiment, a method for making a fingerprint ornamental article includes sending a kit including a photo reactive medium and photo reactive receptor to a customer, so that the customer or another person such as a family member and/or friend can capture at least one fingerprint. The jeweler receives the photo reactive receptor having the fingerprint from the customer so that it can be used to make the fingerprint ornamental article. In using the photo reactive receptor having the fingerprint, the receptor can be scanned into a computer and manipulated in a computer aided design software to create an electronic three dimensional representation of the print.

A wax model based on the electronic three dimensional representation of the print can be created, which is then cast and finished using known techniques. For example, the wax model(s) are then sprued and placed in a flask. An investment is poured into the flask and cured in the flask. The flask including the investment and the wax model is then placed in a burnout oven, such that the wax is burned out and an investment mold is formed having a cavity where the wax model once was. A casting material is cast into the cavity of the investment mold and cooled. The cast material is then removed from the investment mold and polished to obtain the fingerprint ornamental article.

In one embodiment, a method for obtaining a print mark of a portion of a human body includes sending a kit to a customer. The kit includes a photo reactive medium and instructions for use (IFU) to guide the customer or another user, such as a family member or friend, to contact and press a portion of one's body on the photo reactive medium, such as for example a finger. A photo reactive receptor is included in the kit, so that after one has contacted and pressed against the photo reactive medium, the respective portion of the body can then be contacted and pressed against the photo reactive receptor to create a two dimensional print. The captured print on the photo reactive receptor is received by a jeweler.

In one embodiment, a kit for obtaining a two dimensional print mark of a portion of a human body is sent to a customer. The kit includes a photo reactive medium and receptor and instructions for use (IFU) to guide a user of the kit to create a print mark on the photo reactive receptor.

The print created by the photo reactive medium and receptor is exceptionally useful to obtain highly detailed and accurate representations of a print that would be stable to reach a jeweler for production of an ornamental article. As a result, a customer can capture a two-dimensional print of a portion of his/her body, such as at home, and then ship the captured print to a studio for manufacturing and creating the final piece of the personalized ornamental article without damaging the print. The photo reactive medium and receptor can yield a consistently obtainable and readable fingerprint without distortion, with a high amount of detail and accuracy, and where a user has less room for error when making the fingerprint. The photo reactive medium is user-friendly and customer safe.

Other methods for obtaining a print are also described, which do not include using a photo reactive medium and photo reactive receptor. In one embodiment, a method of obtaining a three dimensional print of one's body for manufacturing an ornamental article includes receiving an electronic print of a portion of one's body. The electronic print is created from a digital print reader, where the digital print reader includes a display. The electronic print is inputted into a computer aided design program, and is then manipulated to create a three dimensional representation of the electronic print.

In some embodiments, the digital print reader is standalone device. In other embodiments, the digital print reader is one of a program or an application that may reside on a personal handheld or portable device. In yet other embodiments, the digital print reader is disposed at a kiosk station.

This Summary is an overview of some of the teachings of the present application and not intended to be an exclusive or exhaustive description of the present subject matter. Further details about the present subject matter are found in the detailed description and appended claims. Other aspects of the invention with be apparent to persons skilled in the art upon reading and understanding the following detailed description and viewing the drawings that form a part thereof, each of which are not to be taken in a limiting sense. The scope of the present invention is defined by the appended claims and their equivalents.

### DESCRIPTION OF THE DRAWINGS

The drawings, which are not necessarily drawn to scale, illustrate generally, by way of example, but not by way of limitation, various embodiments discussed in the present document.

FIG. 1 is a flow chart illustrating an embodiment of a method of obtaining a print that can be used for making a personalized ornamental article and a method of making the personalized ornamental article.

FIG. 2 is a schematic illustration of one embodiment of a kit for creating a fingerprint.

FIG. 3 shows one embodiment of another kit including a photo reactive medium and a photo reactive receptor, instructions for use (IFU), an order form, and an envelope.

FIG. 4 shows wax models that would have a three dimensional representation of the print, the models are shown assembled in casting tree on a sprue base.

FIG. 5 shows a sprue base, the casting tree and a flask.

FIG. 6 shows a casting flask that is assembled with the sprue base and casting tree inside.

FIG. 7 shows multiple casting flasks being ready for pouring investment.

FIG. 8 shows the multiple casting flasks with investment poured into each of the flasks.

FIG. 9 shows a burnout oven for burning out the wax and forming an investment mold including a second cavity therein.

FIG. 10 shows one embodiment of a final product of a fingerprint pendant.

FIG. 11 shows another embodiment of obtaining a print which can be electronically obtained and then used to produce a three dimensional representation of the print.

FIG. 12 shows an example of a digital print reader.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and procedure changes may be made without departing from the spirit and scope of the present invention. The flowing detailed description provides examples, and the scope of the present invention is defined by the appended claims and their equivalents.

It should be noted that references to “an,” “one,” or “various” embodiments in this disclosure are not necessarily to the same embodiment, and such references contemplate more than one embodiment.

This document discusses, among other things, a method for obtaining a print and a method of using the print obtained for making personalized ornamental articles. The disclosure herein includes sending a photo reactive medium and photo reactive receptor to a customer so that a print mark of a portion of his/her body can be created.

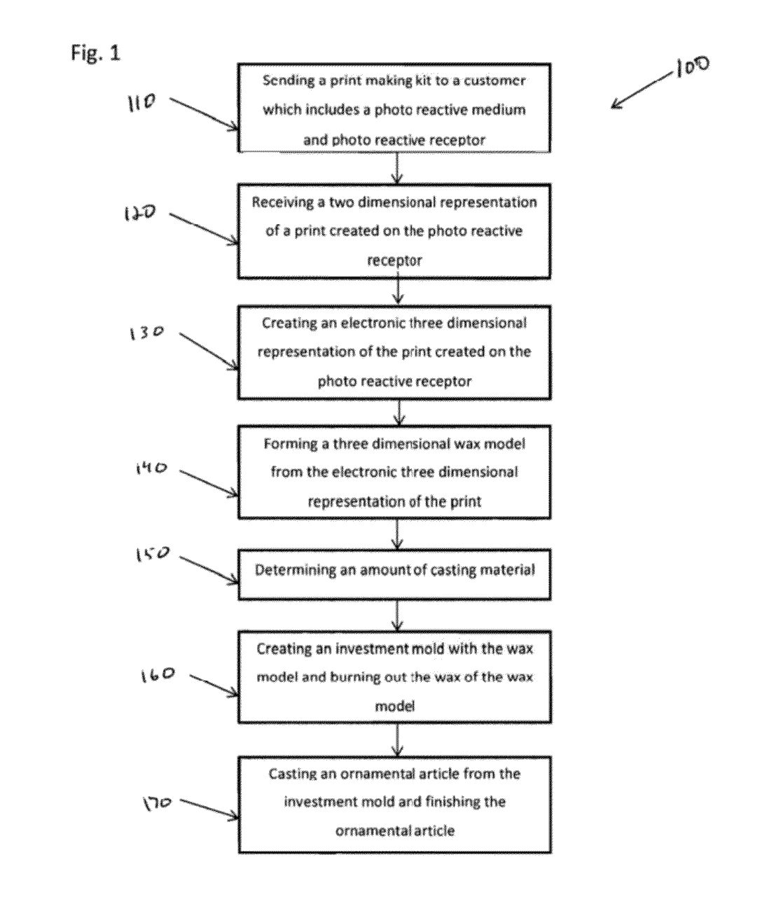

FIG. 1 is a flow chart 100 illustrating an embodiment of a method of obtaining a print. FIG. 1 also illustrates a method of using the print to make a personalized ornamental article

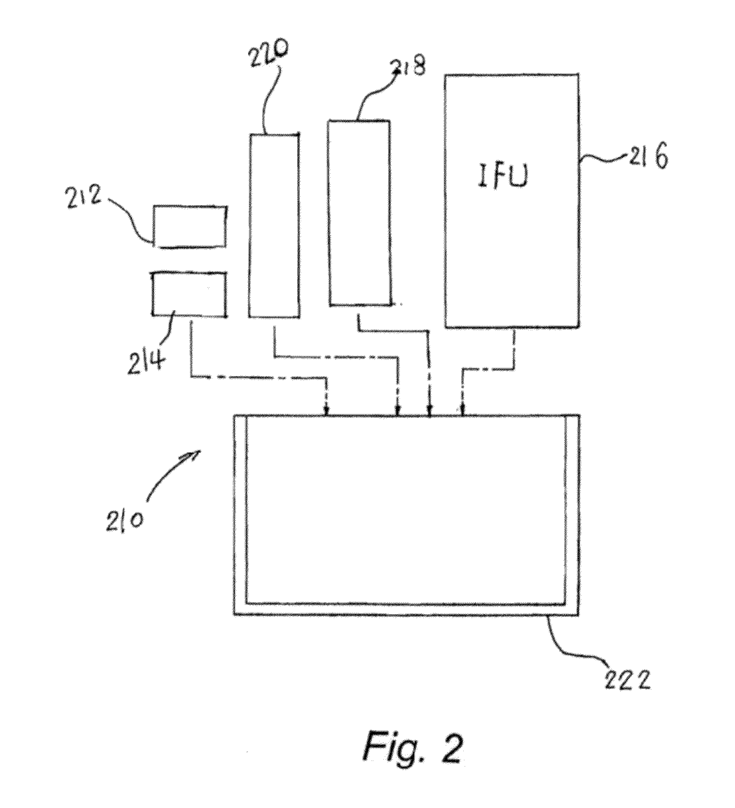

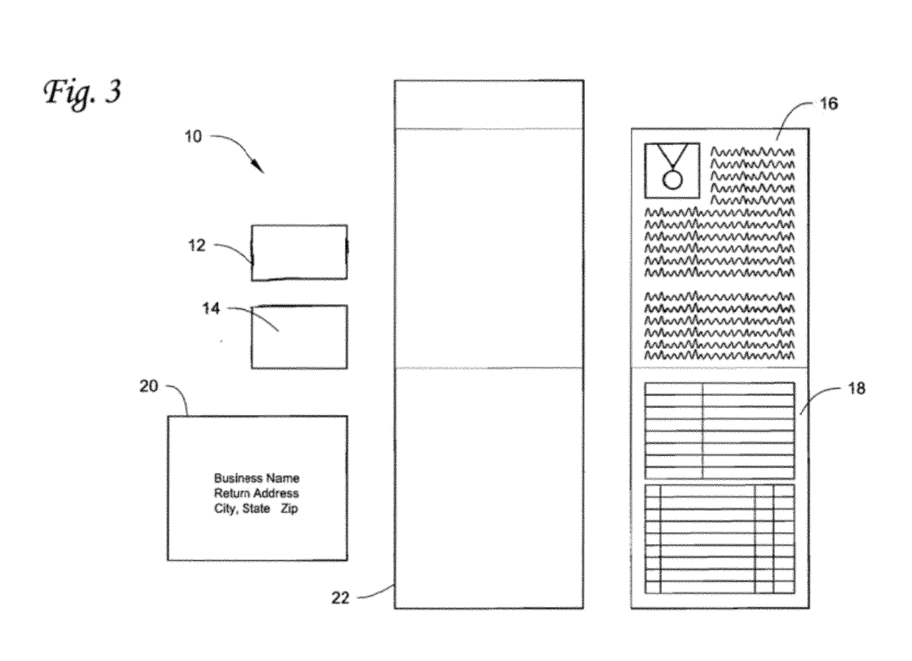

With reference to details of FIG. 1, a print making kit is sent to a customer 110. The print making kit includes a photo reactive medium and photo reactive receptor. In appropriate circumstances, a request or order is received from a customer prior to the kit to be sent, for example, by a jewelry manufacturer. In other cases, an order is not necessarily required, such as for example when such kits are made available by a vendor or distributor of the jeweler manufacturer. The kit is further described below with respect to FIGS. 2 and 3.

A print created on the photo reactive receptor is received by the jewelry manufacturer 120. An electronic three dimensional representation of the print created on the photo reactive receptor is created 130. In some embodiments, this includes electronically scanning the print created on the photo reactive receptor, such as for example into a computer at about 600 dpi resolution. It will be appreciated that the scanned print can be saved as an electronic file and catalogued for future reference.

The scanned print is used to produce the three dimensional representation of the print. In some embodiments, this includes use of a computer aided design software, which can manipulate the print, which is essentially in an electronic two dimensional form, into a three dimensional representation. One suitable example of such software is called Matrix Art within a program called Matrix. The electronic file of the scanned print is imported into the computer aided design software and can be turned into a mesh, which is an electronic modeling of the print in three dimensional form. The mesh can be scaled as needed and placed into a template. The mesh on the template can then be further electronically processed to include needed geometry, which makes up the three dimensional representation of the print.

Three dimensional representation of the print is then used to build a three dimensional wax model 140. In some embodiments, this includes loading a block of wax into a milling machine, such as a four-axis mill. The three dimensional representation of the print is saved as another electronic file which is then imported into the milling machine with suitable mill paths, and the milling machine produces the wax model. The wax model is then used to make a three dimensional ornamental article, such as a piece of jewelry based off the print.

It will be appreciated that conventional jewelry making techniques may be employed at this point to create the ornamental article. In one non-limiting example and for purposes of general discussion, an amount of casting material (e.g. gold, silver, platinum, other precious and non-precious metals) can be measured and weighed based on the wax model 150. An investment mold can be created using the wax model, and then the wax can then be burned out of the investment mold 160. The ornamental article is then cast using the investment mold and then the ornamental article may be subject to further finishing 170, e.g. polishing and treatment.

As described, the print in some embodiments is a fingerprint of a person. However, it will be appreciated that the print can be any portion of one's body and may include a human or animal, such as one's pet.

With reference to the kit, FIGS. 2 and 3 show embodiments of kits which may be useful in the method of FIG. 1. Generally, a kit herein is used to obtain an order for an ornamental article having a print thereon. Such a kit includes a photo reactive medium and a photo reactive receptor. The photo reactive medium and photo reactive receptor are configured so that one can contact the photo reactive medium with a portion of one's body, and then contact the photo reactive receptor to obtain a two dimensional representation of a print of the portion of one's body. The photo reactive receptor with the print created is configured so that it may be used to create a three dimensional mold, e.g. wax mold. A kit herein includes instructions for use, the instructions for use having information on how to create the print using the photo reactive medium and photo reactive receptor. An order form is provided and configured for completion with information on the ornamental article. The kit contains a packaging that contains the photo reactive medium, photo reactive receptor, instructions for use, and order form.

With reference to FIG. 2, a schematic representation of one embodiment of a kit 210 is illustrated. The kit 210 includes a packaging 222 that contains a photo reactive medium 212 and photo reactive receptor 214 which are used to create a print mark. Instructions for use (IFU) 216 are provided which set forth how to use the photo reactive medium 212 and photo reactive receptor 214. An order form 218 for the customer to fill in personal information and any request is included.

In some embodiments, at least one return envelope 220 is included with the kit 210, so that a print created on the photo reactive receptor 214 and order form 218 can be returned to a jewelry manufacturer. Preferably, the at least one return envelope 220 is a postage paid envelope including the return address for the customer to conveniently and quickly send back the print mark. However, in appropriate circumstances and where available, it will be appreciated that the order or print made by a customer may be transmitted electronically from the customer to for example the jewelry maker, rather than through the mails. Such option may be available, if for example the customer can scan in the two dimensional representation of the print and transmit it electronically, such as through the Internet and/or Email.

FIG. 3 shows another embodiment of a kit 10. The kit 10 includes a photo reactive medium 12, a photo reactive receptor 14, instructions for use 16 and an order form 18, and a return envelope 20. These materials can be contained in a packaging structure 22, such as in a folder with a pocket structure, for example an envelope.

With reference to the photo reactive medium, such a medium is a material that when contacted can allow one to make a print or image onto a receptor, where the image is based on the contact made with the medium. In some embodiments, the photo reactive medium is an inkless black image applicator material that can be on a paper, and the photo reactive receptor is a photo reactive paper configured to make the image. One can make the image when one makes contact with the photo reactive receptor after contacting the photo reactive medium. For example, such applicator material can include a specially coated towelette and/or coated paper. For example, the towelette or coated paper can be contacted with one's body, and that portion of the body can then contact the photo reactive receptor to provide a permanent, unsmudged image in seconds. One example of such a suitable medium is the Identifier™, which has been widely used, such as for example, in hospitals to take foot, finger and handprints of newborns. Such a material provides a ‘no ink’, ‘no mess’ way of obtaining a print that is safe and non-toxic.

With further reference to the photo reactive receptor, the receptor may be configured to allow for multiple prints to be made, such that a user can undergo several trials if needed to obtain a high quality acceptable print. For example, the photo reactive receptor, e.g. paper, can have several areas on which to create a print using the photo reactive medium, e.g. inkless black image applicator. The photo reactive receptor may also include a space so that information about the print may be entered, for example one's name, age, specific print made, etc.

With reference to the instructions for use, it will be appreciated that instructions for use may be on any one or more of the photo reactive receptor, the photo reactive medium, or a packaging which may separately contain either the photo reactive receptor or photo reactive medium.

With further reference to the order form, a customer may use the order form to fill in personal information (e.g. name, address, method of payment and payment information) and any request(s). The order form 18 can also include choices for the final product. Such choices for the final product can include but are not limited to: the type of product, such as a pendant or charm/bracelet; the type of metal, such as a certain carat of gold or sterling silver; the sizing of the product such as the chain for the pendant or charmed bracelet; an option for diamond bail, and/or an option for engraving.

With further reference to using the kit to obtain a print, a customer that receives the kit can create a print mark of a portion of his/her body or have another person such as a family member or friend do so. The print created can then be sent back to the jewelry manufacturer.

In operation, for example, a person may use the kits herein in his/her home or otherwise away from a place of business of the jewelry manufacturer. It will be appreciated that in appropriate circumstances, the kits may be used to make a print at the place of business of jewelry manufacturer. As described above, a user can create a print by contacting the photo reactive medium with a portion of the body, e.g. finger, and then contacting that portion of the body to the photo reactive receptor. If necessary, these steps can be repeated until a desired print mark has been created. Once an acceptable print mark is formed, the customer and/or user of the kit in some embodiments may write a desired engraving on a part of the photo reactive receptor that does not have the print, on the order form, or separate paper and return the order form and photo reactive receptor to the jewelry manufacturer, e.g. by return mail.

After the print is received by the jewelry manufacturer, the print mark can be labeled with information of the person the printmark belongs to, for example a customer's name and a date of significance, such as but not limited to when the print mark is made such as a birthdate or any date of significance, or any information helpful for recording and cataloguing purposes.

Once the printmark is received by the studio, the print can be used to produce an ornamental article, such as a piece of jewelry using known manufacturing processes.

FIGS. 5-10 illustrate an embodiment of jewelry manufacturing, with some further detail on steps 150, 160, and 170 in FIG. 1. For example, a ‘lost wax’ casting process may be used to cast the final piece of the personalized ornamental article. It will be appreciated that the lost wax casting process is well known in the jewelry manufacturing industry.

Specifically, the wax model is first sprued and weighed. The use and operation of sprues is well known and understood, for example in the art of making jewelry. For example, at least one sprue can be attached to the wax model to provide paths for the molten casting material to flow and for air to escape. Spruing, for example, can be carefully planned with certain sizes and locations of sprues to help achieve an accurate turn out of the final piece of the personalized ornamental article. The weight of the wax is used for determining how much material for the final piece of the ornamental article is needed for the casting.

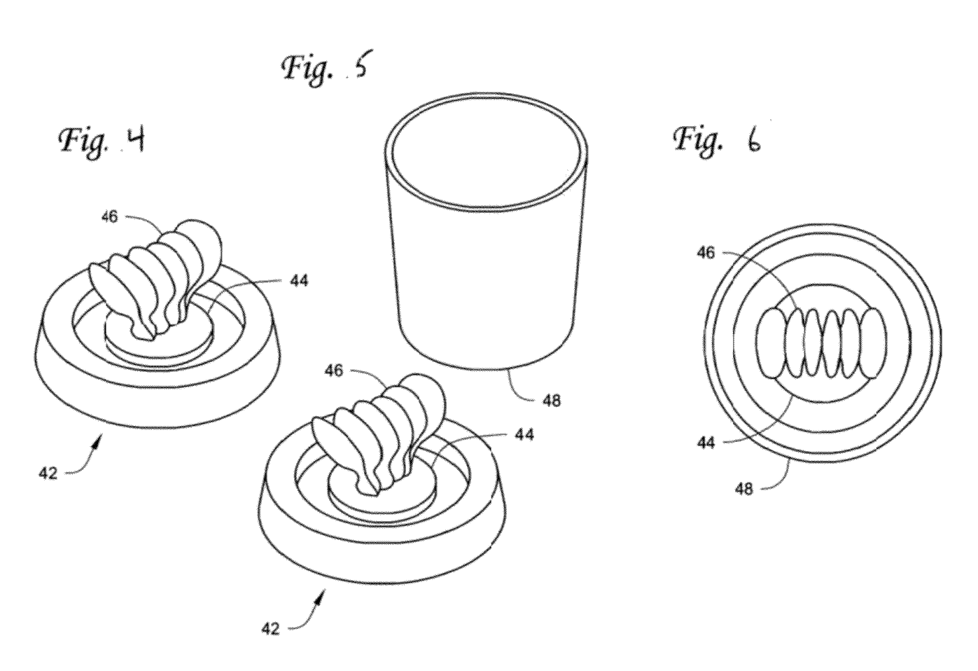

The sprued wax model is attached to a sprue base, and then put into a flask together. In some embodiments, a plurality of wax models can be attached to the sprue base for casting multiple ornamental articles at one time. The base having multiple wax models attached thereon is called a casting tree, which are known for example in the art of making jewelry. FIG. 4 shows an assembled casting tree 42 having six wax models 46 on a sprue base 44. FIG. 5 shows a casting tree 42 including the multiple wax models 46 and sprue base 44 and a flask 48. FIG. 6 shows a casting flask 48 that is assembled, which has a casting tree including the sprue base 44 and wax models 46 therein.

In some embodiments, a finding may be used, which is well known. The term “finding” includes a functional element that is attached to the main body of a jewelry item for manufacturing or repair. The finding can be attached to the wax model to create a cavity discussed for a hanging mechanism to form integrally with the final piece of the ornamental article. It will be appreciated that the finding can be attached during the finishing process after casting or any suitable part of the process. Generally, findings are well known and their operation is well understood, for example in the art of making jewelry. In one embodiment, the finding is in a shape of a small loop and thereby creates a cavity in a shape of a loop such that, in the final piece of the personalized ornamental article, a small loop is integral with the ornamental article. It will be appreciated that the finding can be made of a variety of materials, for example, other metals, plastics or waxes, as long as they can be put in a mold and create a cavity.

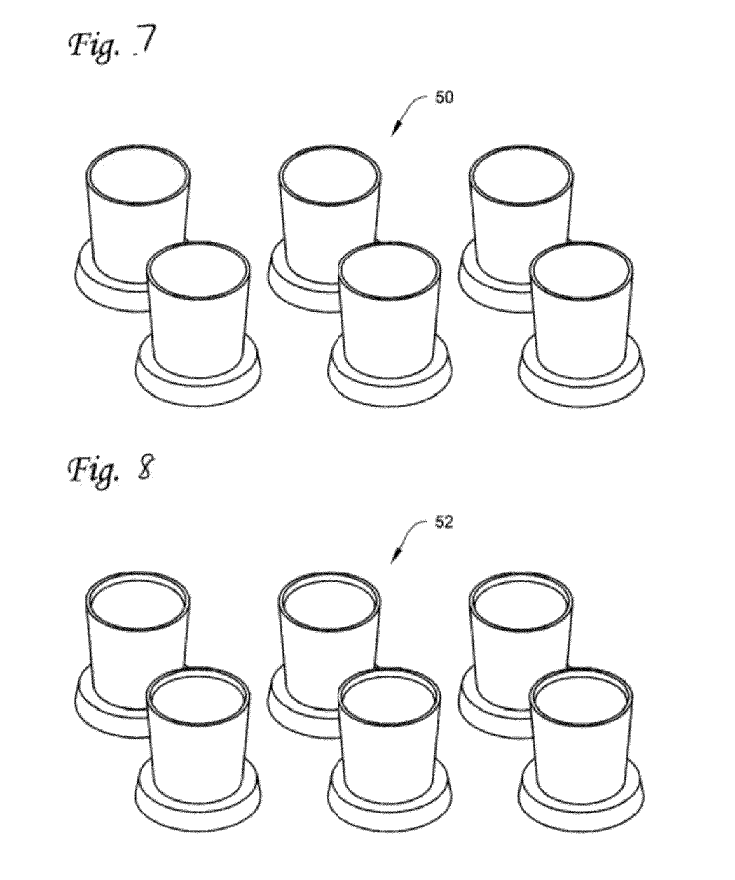

Once the wax model is ready, an investment mold can be created using the wax model. The investment mold is then used to cast the ornamental item having the three dimensional representation of the print. In one embodiment, a plurality of flasks is prepared and ready for an investment to be poured into. The term “investment,” as used in this document, includes a powder that when mixed with water is able to harden creating a mold that can be, and is often used in the lost wax casting process. FIG. 7 shows multiple flasks 50 ready for investment to be poured into the flasks.

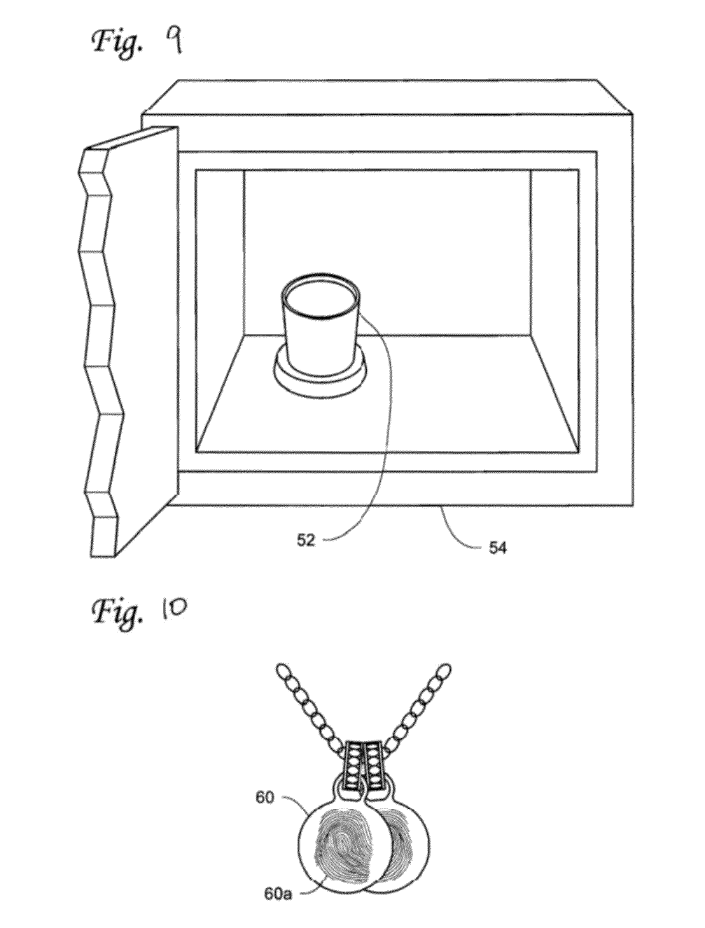

A reasonable amount of investment is mixed, degassed and then poured into a flask and cured. FIG. 8 shows multiple flasks 52 including the investment poured therein.

The flask is then separated from the sprue base, and then, with the investment and wax model inside the flask, is placed into a burnout oven to burn the wax out. The heat of the burnout oven hardens the investment into a shell, while the wax is melting and running out. FIG. 9 shows a burnout oven 54 for burning out the wax and forming an investment mold including a second cavity therein.

A casting material for making the final piece of the ornamental article is then prepared and weighed. The casting material can be anything that the customer chooses for the casting, such as but not limited to, any karat or color gold, fine silver, sterling silver, copper, brass, bronze, pewter, base metal, white metal, pot metal, platinum or palladium, etc. The casting may be performed by any one of centrifugal, vacuum, and induction casting into the mold. It will be appreciated that centrifugal, vacuum, and induction casting are well known in the jewelry manufacturing industry as various techniques for carrying out the lost wax casting process and are not further described. The casting material and the investment mold are then allowed to cool down.

The casting material is taken out from the investment mold and the casting signs and the stubs of spruing are then removed. After the rough surface of the cast product is filed and polished, the final piece of the personalized ornamental article is obtained at 170 in FIG. 1.

It will be appreciated that the ornamental article can be assembled to not only a piece of jewelry, but also a gift item. Examples of jewelry, and specifically fine and costume jewelry, that the personalized ornamental article can be assembled to include, rings, pendants, bracelets, earrings, cuff links, etc. Examples of gift items include paper weights, key chains, money clips, picture frame adornments, baby book adornments, baby flatware, comfort stones, memorials pocket coins, wallet reminders, holiday ornaments, etc. Once the ornamental article is assembled, it can be shipped to the customer. FIG. 17 shows one example of a final product as a fingerprint pendant 60 (with casted printmark 60a).

As described herein, obtaining a print includes a print of a portion of a human or animal body, e.g., fingerprint, footprint, paw, etc. In the embodiments described with respect to FIGS. 1-3, the print is made by contacting and pressing a portion of the body onto a photo reactive medium and then contacting and pressing the portion one's body onto a photo reactive receptor. The photo reactive medium and receptor are materials that can accurately capture a two-dimensional representation of a print on the receptor, which can then be suitably used to obtain a three dimensional mold. By using the photo reactive medium and receptor, a print for example a fingerprint can be made which sets quickly, has a high amount of detail, and which is difficult to compromise until it reaches a jeweler, such as for example during shipping. The print that is captured is stable, such that it is suitable for long term storage, cataloguing, and reuse of the print. The photo reactive medium is also suitable for being electronically scanned for cataloguing and later use.

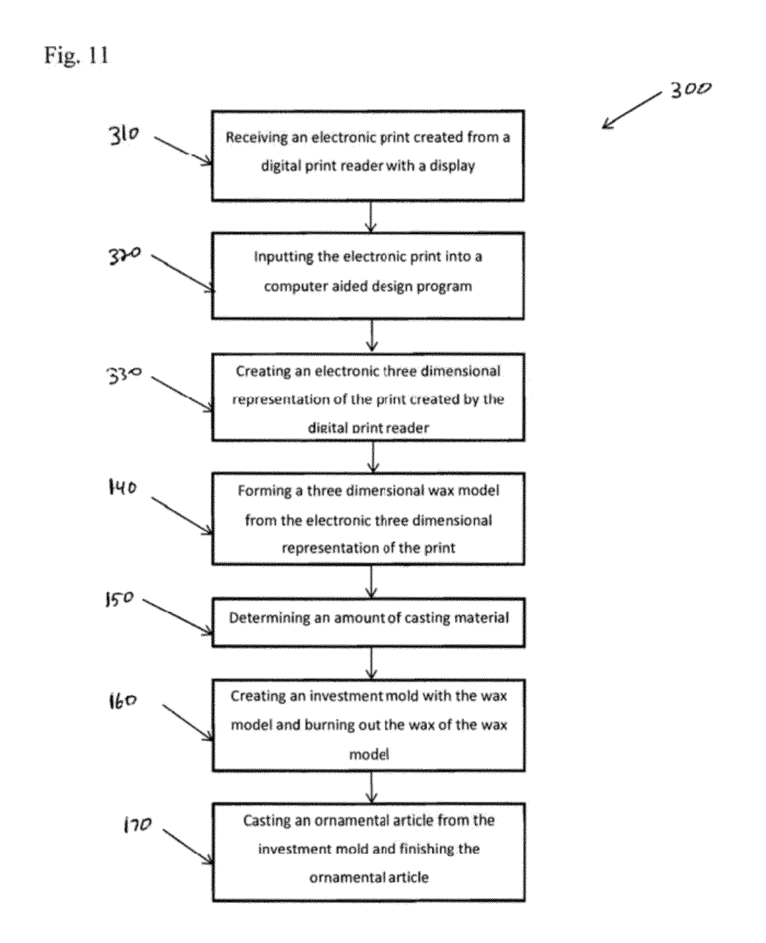

It will be appreciated that other methods for obtaining a print can be employed. FIG. 11 shows another embodiment of a method 300 of obtaining a three dimensional print of one's body for manufacturing an ornamental article comprising. As shown, an electronic print of a portion of one's body can be received 310, where the electronic print is created from a digital print reader. The digital print reader can include a display, such as a computer screen or monitor or other suitable electronic display, which may or may not be on the digital print reader. The electronic print is then inputted into a computer aided design program 320, and the electronic print can then be manipulated to create a three dimensional representation of the electronic print 330.

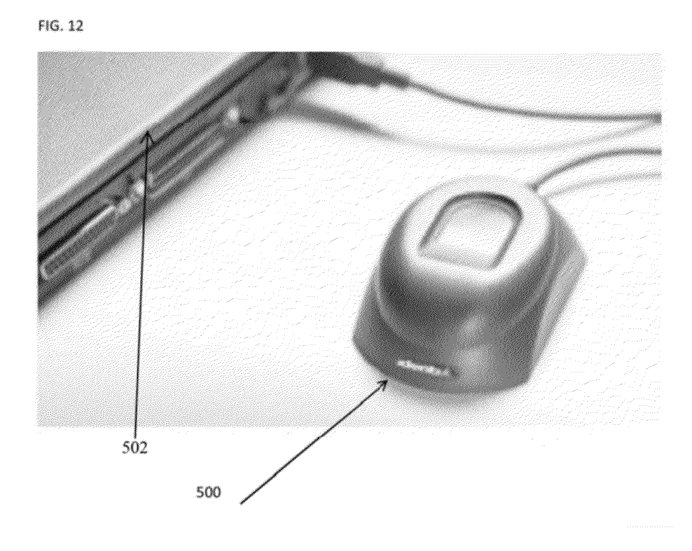

With reference to the digital print reader, in some embodiments a digital print reader is standalone device, such as an off the shelf product, that is configured to create the electronic print when contact is made with the display. The digital print reader has the capability to electronically transmit the electronic print to a processor, such as a computer. One example of a suitable digital print reader is by Identix® BioTouch™ USB 200. FIG. 12 shows one embodiment of a digital print reader 500, which includes a main body with a display, and that is a peripheral standalone device. As shown, the digital print reader 500 can be connected to a computer 502 such as a laptop. It will be appreciated that the digital print reader can include or be configured for use with a software program on a computer.

In other embodiments, the digital print reader is one of a program or application that may reside on a personal handheld device, such as a smart phone or other portable electronics. Such a program or application is configured to create the electronic print when contact is made with the display. The program or application is configured to allow transmission of the electronic print to a processor, for example to create a file that can be emailed. In yet other embodiments, the digital print reader is disposed at a kiosk station, such as at a shopping mall, jewelry store, department store, and other retail areas, etc.

With further reference to FIG. 11, once the electronic print is obtained, similar steps as in FIG. 1 and described above (e.g. steps 140 to 170) may be employed to produce a finished ornamental article.

It is to be understood that the above detailed description is intended to be illustrative, and not restrictive. The scope of the invention should, therefore, be determined with reference to the appended claims, along with the full scope of equivalents to which such claims are entitled.

1. A kit to create an order for an ornamental article having a print thereon comprising:
a photo reactive medium;
photo reactive receptor,
the photo reactive medium and photo reactive receptor to obtain a two dimensional representation of a print of the portion of one's body, so that one can contact the photo reactive medium with a portion of one's body, and then contact the photo reactive receptor, the photo reactive receptor with the two dimensional representation of the print to create a three dimensional mold used to produce the ornamental article with the print;
to instructions for use, the instructions for use having information on how to create the print using the photo reactive medium and photo reactive receptor;
an order form, the order form is configured for completion with information on the ornamental article; and
packaging that contains the photo reactive medium, photo reactive receptor, instructions is for use, and order form.

2. The kit of claim 1, wherein the photo reactive medium is an inkless black image applicator material disposed on a paper.

3. The kit of claim 1, wherein the photo reactive receptor is a photo reactive paper configured to receive the photo reactive medium.

4. The kit of claim 1, further comprising a return envelope.

5. The kit of claim 4, wherein the return envelope is a postage paid return envelope.

6. The kit of claim 1, wherein the print is a fingerprint of a person.

7. A method for obtaining an order for an ornamental article with the kit of claim 1, comprising:
a) sending a kit to a customer, the kit comprising
a photo reactive medium,
photo reactive receptor,
the photo reactive medium and photo reactive receptor to obtain a two dimensional representation of a print of the portion of one's body, so that one can contact the photo reactive medium with a portion of one's body, and then contact the photo reactive receptor, the photo reactive receptor with the two dimensional representation of the print to create a three dimensional mold used to produce the ornamental article with the print;
instructions for use, the instructions for use having information on how to create the print using the photo reactive medium and photo reactive receptor,
an order form, the order form is configured for completion with information on the ornamental article, and
packaging that contains the photo reactive medium, photo reactive receptor, instructions for use, and order form; and
b) receiving the print created on the photo reactive receptor.

8. The method of claim 7, further comprising receiving a request from the customer prior to sending the kit.

9. The method of claim 7, further comprising cataloguing the print created on the photo reactive receptor.

10. A method for manufacturing an ornamental article with an impression made thereon comprising:
a) sending a kit to a customer, the kit comprising
a photo reactive medium,
photo reactive receptor,
the photo reactive medium and photo reactive receptor to obtain a two dimensional representation of a print of the portion of one's body, so that one can contact the photo reactive medium with a portion of one's body, and then contact the photo reactive receptor, the photo reactive receptor with the two dimensional representation of the print to create a three dimensional mold used to produce the ornamental article with the print;
instructions for use, the instructions for use having information on how to create the print using the photo reactive medium and photo reactive receptor,
an order form, the order form is configured for completion with information on the ornamental article, and
packaging that contains the photo reactive medium, photo reactive receptor, instructions for use, and order form;
b) receiving the print created on the photo reactive receptor;
c) creating an electronic three dimensional representation of the print created on the photo reactive receptor;
d) forming a three dimensional wax model from the three dimensional representation of the print;
e) weighing the wax model to determine an amount of casting material;
f) creating an investment mold using the wax model and burning out the wax;
g) casting an ornamental article in the investment mold by using the determined amount of casting material; and
h) finishing, if needed, the cast ornamental article with the three dimensional representation of the print thereon.

11. The method of claim 10, wherein the kit further comprises a return envelope.

12. The method of claim 11, wherein the return envelope is a postage paid return envelope.

13. The method of claim 10, wherein the print is a fingerprint of a person.

14. The method of claim 10, further comprising cataloguing the print.

15. A method of obtaining a three dimensional print of one's body for manufacturing an ornamental article comprising:
receiving an electronic print of a portion of one's body, the electronic print being created from a digital print reader, the digital print reader includes a display;
inputting the electronic print into a computer aided design program; and
manipulating the electronic print to create a three dimensional representation of the electronic print.

16. The method of claim 15, wherein the digital print reader is standalone device to create the electronic print when contact is made with the display and electronically transmit the electronic print to a processor.

17. The method of claim 15, wherein the digital print reader is one of a program or application that resides on a personal handheld device, the program or application to create the electronic print when contact is made with the display, and the program or application to allow transmission of the electronic print to a processor.

18. The method of claim 15, wherein the digital print reader is disposed at a kiosk station.
